(19) United States
(12) Patent Application Publication
(10) Pub. No.: US 2002/0130777 A1
(43) Pub. Date: Sep. 19, 2002

(54) Envelope for the transport or storage of ducuments or valuables and security device provided with such an envelope

(75) Inventor: Philippe Besnard, Griselles (FR)

Correspondence Address: YOUNG & THOMPSON, 745 SOUTH 23RD STREET 2ND FLOOR, ARLINGTON, VA, 22202

(73) Assignee: BRINK'S FRANCE, Paris (FR)

(21) Appl. No.: 10/095,034

(22) Filed: Mar. 12, 2002

(30) Foreign Application Priority Data
Mar. 15, 2001 (FR) 0103555

(51) Int. Cl. G08B 13/14

(52) U.S. Cl. 340/568.7; 340/568.1; 340/545.6; 340/550

(57) ABSTRACT

An envelope for the transport or storage of documents or securities or valuables has in its walls an electrically conductive network formed from at least one electrically conductive wire, means of closing the envelope also forming means of closing the circuit formed by the electrically conductive network, means of connecting the network to a neutralisation and/or destruction and/or signalling device intended to be placed in the envelope, the density of the network being such that an attempt at opening the envelope by cutting or tearing thereof causes the breaking of the at least one electrically conductive wire and a change in the resistance of the network capable of causing the triggering of the neutralisation and/or destruction and/or signalling device.

### BACKGROUND OF THE INVENTION

The present invention relates to the transport or storage of money and more particularly the security devices intended to accompany the transported money and be associated with remote monitoring and control devices in order to provide the neutralisation and/or destruction of banknotes or other valuables immediately upon the appearance of an anomaly in the conditions of transport of the corresponding money or to locate them during their transport or in the case of theft.

### DESCRIPTION OF THE PRIOR ART

Amongst the security devices for the transport of money, secure cases are known having means of neutralising the documents or banknotes they contain, by dispersal of ink making notably the notes unusable.

The aforementioned neutralisation means include for example a system for pyrotechnic triggering in the event of an attempt at forcible entry, said triggering system being parameterisable.

However, a secure case has the drawback of containing a limited number of notes compared with the large volume of ink it has to contain to provide the neutralisation of these notes.

Furthermore, the use of secure cases often requires the transport vehicles to be fitted out by providing, in a vehicle, compartments for receiving the cases and equipping these compartments with means of detecting the withdrawal of each case out of its compartment.

### SUMMARY OF THE INVENTION

The invention aims to overcome the drawbacks of existing security devices by creating a security device for the transport or storage of valuables in bulk contained in bags or envelopes which, while being of a relatively simple and inexpensive construction, allows the valuables contained in the bags or envelopes to be made unusable as soon as an attempt is made to withdraw them or which makes it possible to monitor the route of bags or envelopes during their transport by an authorised company or after their theft.

According to one aspect of the present invention, there is provided an envelope for the transport or storage of documents or valuables, wherein the envelope comprises walls, in which an electrically conductive network is formed from at least one electrically conductive wire, there being means to close the envelope, which means also forms means to close a circuit formed by said electrically conductive network, there being means to connect said network to a device for neutralisation and/or destruction and/or signalling intended to be placed in said envelope, and wherein said network has a density that is such that an attempt at opening the envelope by cutting or tearing thereof causes the breaking of said at least one electrically conductive wire and a change in the resistance of said network capable of causing the triggering of the device for neutralisation and/or destruction and/or signalling.

The electrically conductive network may be formed from a single wire disposed in successive turns in the walls of the envelope.

The electrically conductive network may be formed from a number of electrically conductive wires disposed in the walls of the envelope and connected in series.

The turns in one wall may be interleaved with the turns in the other wall.

The turns in each wall of the envelope may have end loops extending onto the adjacent wall.

The turns in one of the walls may have end loops extending onto a side fold-over section for fixing the walls of the envelope to one another, provided on one of said walls.

Said at least one conductive wire of said network may be wound in a helix on the walls of the envelope;

The electrically conductive network may be disposed between two sheets of plastic whose superposition forms the walls of the envelope.

The electrically conductive network is incorporated into a sheet of plastic from which the envelope is produced.

Said means of connecting the network to the neutralisation and/or destruction and/or signalling device may comprise two flying conductors each extending an interrupted portion of the electrically conductive wire forming said network and having, at their end, means of connecting with a complementary connector of said neutralisation and/or destruction and/or signalling device.

According to another aspect of the present invention, there is provided a security device for the transport and storage of documents or valuables, comprising an envelope, wherein the envelope comprises walls, in which an electrically conductive network is formed from at least one electrically conductive wire, there being means to close the envelope, which means also forms means to close a circuit formed by said electrically conductive network, there being means to connect said network to a device for neutralisation and/or destruction and/or signalling intended to be placed in said envelope, and wherein said network has a density that is such that an attempt at opening the envelope by cutting or tearing thereof causes the breaking of said at least one electrically conductive wire and a change in the resistance of said network capable of causing the triggering of the device for neutralisation and/or destruction and/or signalling; and wherein a device is connected to said electrically conductive network, said device connected to said electrically conductive network being for neutralisation and/or destruction of the valuables contained in the envelope and/or for signalling the forcible entry of said envelope and being located in said envelope and comprising means sensitive to the change in resistance of the electrically conductive network through breaking of at least one conductive wire of said network in order to trigger the action of the device for neutralisation and/or destruction of the content of said envelope and/or for signalling its location.

The neutralisation and/or destruction and/or signalling device may have a reservoir of staining and/or destroying product, distributing means, and a trigger for said reservoir, the trigger for said reservoir being controlled by a microprogrammed system connected to said conductive network of said envelope.

The neutralisation and/or destruction and/or signalling device may be a target device for a monitoring and control device and the microprogrammed circuit may furthermore be connected to a radio-frequency circuit for receiving periodic activation signals coming from the monitoring and control device, inside a predetermined security area defined by the monitoring and control device, and for transmitting, to said microprogrammed circuit, information about activation signal absence during a parameterisable time interval indicating the exit of the neutralisation and/or destruction and/or signalling device out of said security area in order to cause the operation by the microprogrammed circuit of the destruction of the valuables contained in the envelope or of said radio-frequency circuit with a view to the issuing thereby of an alarm signal.

The radio-frequency circuit may also be sensitive to the reception, outside the period of the activation signals, of signals other than those coming from the monitoring and control device capable of causing the operation by the microprogrammed circuit of the reservoir trigger and the neutralisation and/or destruction of the valuables contained in the envelope.

The first activation signal of the microprogrammed circuit may be a signal for activating the neutralisation and/or destruction and/or signalling device with a view to making it sensitive to the breaking of the electrically conductive network of said envelope in order to trigger the neutralisation and/or destruction of the valuables contained in the envelope or the triggering of an alarm.

### BRIEF DESCRIPTION OF THE DRAWINGS

For a better understanding of the invention and to show how the same may be carried into effect, reference will now be made, by way of example, to the accompanying drawings, in which:-

FIG. 1 is a schematic view in perspective of an envelope for the transport or storage of documents or valuables, associated with a neutralisation, destruction or signalling device;

FIG. 2 is a plan view of an unfolded surface of the envelope of FIG. 1; and

FIG. 3 is a more detailed schematic view of the neutralisation, destruction or signalling device associated with the envelope for transport or storage of documents or valuables.

### DESCRIPTION OF THE PREFERRED EMBODIMENTS

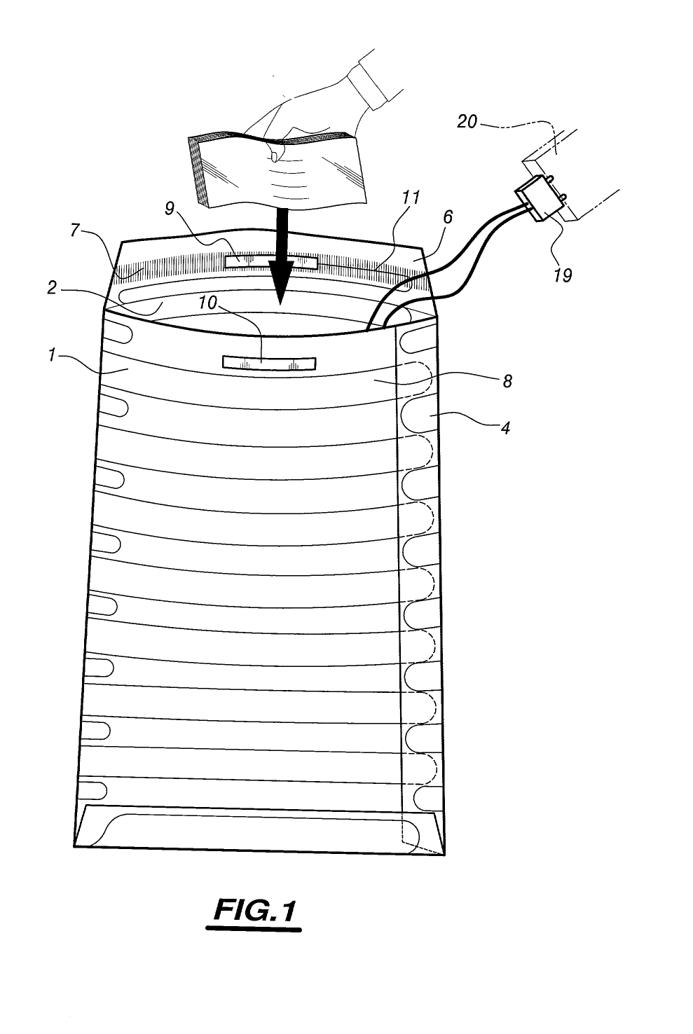

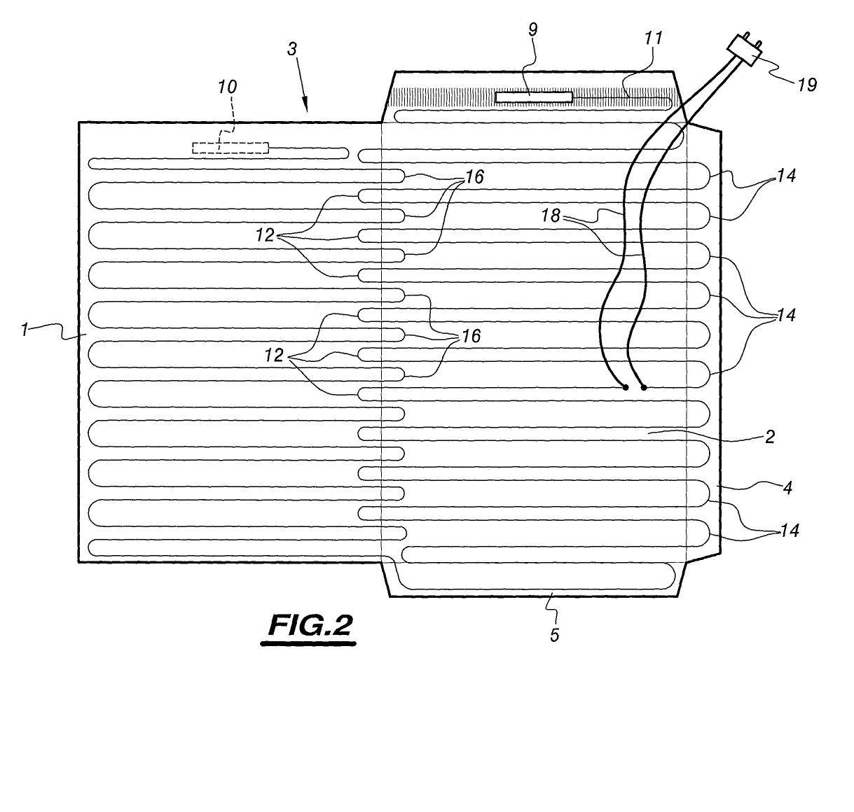

The envelope E depicted in FIG. 1 is a single-use envelope of rectangular shape, for example made of plastic having first and second walls 1 and 2 formed by folding of corresponding faces of a sheet of plastic 3 depicted in FIG. 2.

The wall 1 is fixed onto the wall 2 by a side fold-over section 4 and a bottom fold-over section 5 which are also depicted in FIG. 2.

At its end opposite to the bottom flap 5, the envelope has an additional fold-over section or closing flap 6 covered with an adhesive 7 intended to be applied onto an adhesive-covered surface 8 of the wall 1 in order to provide the hermetic closure of the envelope after the insertion therein of the securities or valuables V or documents to be transported or stored.

On the flap 6 and the corresponding surface 8 of the wall 1, there are disposed electrically conductive respective strips 9 and 10 connected to one another by a conductive wire 11 intended to form a conductive network over the whole surface of the envelope disposed in successive turns 11a, 11b over the walls 2 and 1 of the envelope in a manner depicted in more detail in FIG. 2.

It can be seen in this figure that the conductive wire 11 connected to the conductive strip 9 is disposed in successive turns so as to wind first along the surface of the wall 2 extending beyond this by means of end loops 12 onto the wall 1 and by means of end loops 14 onto the side fold-over section 4.

The conductor 11 also passes over the bottom fold-over section 5 and then travels over the wall 1 by means of successive turns 11b interleaved between the turns formed on the wall 2 and having end loops 16 extending onto this wall 2.

Finally, the conductor 11 is connected to the conductive strip 10.

Returning to FIG. 1, it can therefore be seen that the envelope closure device formed by the flap 6 extending the wall 2 and the adhesive area 8 of the wall 1 provides, upon application of the flap 6 onto the adhesive area 8, the closure of the electrical circuit formed by the conductor 11 by application of the conductive strip 9 onto the conductive strip 10.

The conductive wire 11 is interrupted at a point 17 inside the envelope E and its two sections have extensions 18 connected to a connector 19 for connection to a neutralisation and/or destruction and/or signalling device 20. At least the sections 18 are advantageously covered with an insulating sleeve.

The device 20, once connected to the extensions 18 of the conductor 11, is disposed in the envelope with the documents or valuables V to be stored or transported.

The density of the electrically conductive network formed by the conductive wire 11 disposed on the walls 1 and 2 of the envelope E is sufficient so that any attempt at opening this envelope by cutting or tearing one of its walls anywhere whatsoever causes the breaking of the conductive wire 11 and consequently a large increase in the resistance of the network which it forms capable of triggering the neutralisation and/or destruction and/or signalling device 20.

In particular, the loops 12, 14, 16 of the turns 11a, 11b of the conductive wire 11 formed in the side fold-over section 4 and in the walls 1 and 2 constitute, after folding of the walls 1 and 2 upon one another and their fixing by means of the fold-over section 4, so many areas of protection against forcible entry of the envelope by the edges thereof.

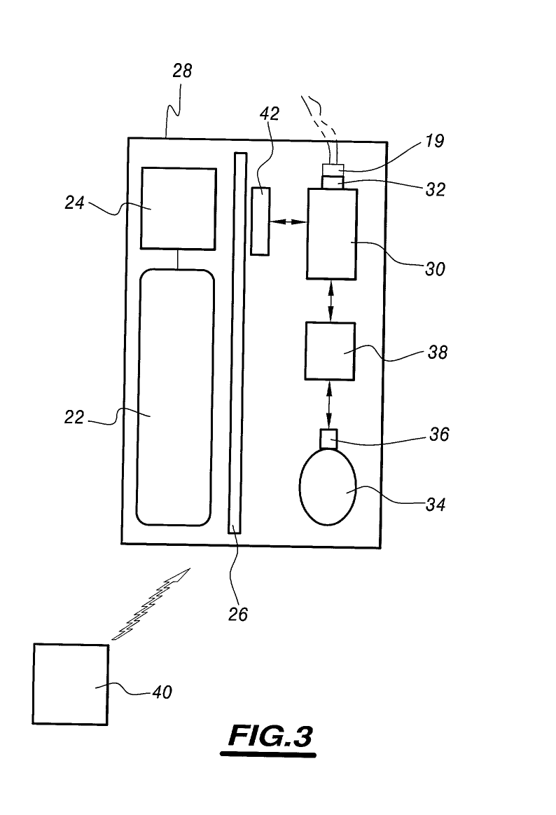

As depicted in FIG. 3, the neutralisation and/or destruction and/or signalling device 20 includes a reservoir 22 of product for staining and/or destroying the valuables or documents contained in the envelope, with which there is associated an electromechanical trigger 24 for opening the reservoir with a view to allowing the flowing out of the product it contains through a slot 26 made in the casing 28 of the device with a view to neutralising or destroying the documents or valuables contained in the envelope E with the device 20.

The casing 28 also contains a microprogrammed system 30 intended to control the triggering device 24 and having a connector 32 by means of which it is connected to the connector 19 of the electrically conductive network of the envelope E.

Also connected to the microprogrammed system 30 is a radio-frequency antenna 34 connected to a device 36 for storing an electronic label for identifying the neutralisation and/or destruction and/or signalling device 20 and the valuables or documents with which it is associated. This electronic label storage device is in its turn connected to the microprogrammed system 30 by means of a radio-frequency coupler 38.

The neutralisation and/or destruction and/or signalling device 20 forms a target device for a remote monitoring and control device 40 intended to send, to the device 20, periodic activation signals when the neutralisation and/or destruction and/or signalling device is situated inside a security area defined by the monitoring and control device 40.

Such a monitoring and control device can be situated in the premises of a bank or a transport company delivering banknotes, in a vehicle, armoured or not, for transport by road, rail or other means and in the premises of a company for which the banknotes are destined.

Non-reception of the activation signals by the antenna 34 during a parameterisable time interval causes the issuing by the microprogrammed circuit 30 of a signal for operating the triggering device 24 and therefore the opening of the reservoir 22, which provides the flowing out of its content through the slot 26 in the casing 28 into the envelope and the staining and/or destruction of the valuables or documents it contains.

The first signal for activation of the programmed circuit 12 by the monitoring and control device 40 is a signal for activation of the assembly formed by the microprogrammed circuit 30 and the conductive network formed by the conductive wire 11 of the envelope.

This first activation signal also makes it possible to verify that the envelope E has been properly closed by application of the conductive strip 9 of the flap 6 onto the conductive strip 10 of the wall 1 of the envelope.

If such is not the case, the microprogrammed system 30 cannot be activated.

The monitoring and control device 40 which defines the aforementioned security area is for example of the type described in French patent application No. 01 02 750filed on Feb. 26, 2001 by the applicant.

The radio-frequency circuit formed by the antenna 34 and the radio-frequency coupler 38 is also adapted to receive, for example from a remote surveillance or some other device (not depicted), a signal outside the periodicity of the activation signals received from the monitoring and control device 40 so that this also causes, by means of the microprogrammed circuit 30, the operation of the triggering device 24 and consequently the discharge of the product contained in the reservoir 22 onto the documents or valuables contained in the envelope, by this product flowing out through the slot 26 in the casing 28.

Such an action of the device is caused for example at the time of an attack on the transport vehicle containing the envelope and the neutralisation and/or destruction and/or signalling device 20 associated therewith, signalled by the driver of a transport vehicle to a remote surveillance device which sends a destruction command signal to the antenna 34, the latter transmitting said signal by means of the radio-frequency coupler 38 to the microprogrammed system 30.

Finally, the microprogrammed circuit 30 has means, not depicted, allowing its neutralisation when the envelope in which it is situated with the documents or valuables it contains arrives without incident at its destination.

The neutralisation or sensitisation of the microprogrammed circuit 30 is provided by a control apparatus situated in the premises of the addressee of the envelope and which can notably form part of a monitoring and control device defining a security area such as the monitoring and control device 40.

The microprogrammed circuit 30 is advantageously formed from a microprogrammed card based on a microcontroller for example of the PIC 16C type or a similar industrial microcontroller which controls the trigger 24 and is connected to the radio-frequency coupler circuit 38 and to the antenna 34 and to the resistance constituted by the electrically conductive network formed by the conductor 11 of the envelope E.

The radio-frequency circuit formed by the antenna 34 and the radio-frequency coupler 38 operate advantageously at a frequency of 900 MHz or 2.45 MHz and its electronic label storage device 36 is of the read/write radio-frequency type.

The power supply of the neutralisation and/or destruction and/or signalling device 20 is provided for example by a Lithium 42 cell whose life is 3 to 5 years or by a rechargeable battery.

The neutralisation and/or destruction and/or signalling device 20 can also be used in a signalling device intended to indicate a forcible entry committed on the envelope E and its content.

To that end, the activation of the microprogrammed system 30 allows the issuing thereby of alarm signals intended for example to operate a warning device such as a siren or some other device.

In the example just described, the envelope according to the invention has a conductive network formed from a single conductor disposed in turns on the walls 1 and 2 of the envelope.

It is of course possible to adapt the density and number of these turns according to the security to be obtained with regard to the possibilities of penetrating the envelope by cutting or tearing.

Furthermore, it is also possible to dispose the conductive wire forming the protective network of the envelopes according to other configurations, for example by winding the conductive wire in a helix on the walls of the envelope.

The conductive wire forming the network is for example disposed between two sheets of plastic or paper defining the walls of the envelope E.

It can also be embedded in the material of the sheet of plastic or paper intended for producing the envelope.

The envelope just described is adapted for use with a number of types of target device such as that just described, or a device of the type assembled with a bundle of notes by binding or other means.

It is sufficient for the target device to have a connector allowing the connection of the conductive network of the envelope to its microprogrammed circuit.

Although in the example just described the invention has been considered as being applied to a plastic envelope, it can also be implemented with paper envelopes and bags, for example cloth bags in which the conductive wire forming the aforementioned network is incorporated by weaving.

Instead of using a single continuous wire, it is also possible to implement the invention using, for producing the conductive network, a number of wires connected in series.

I claim:

1. An envelope for the transport or storage of documents or valuables, wherein the envelope comprises walls, in which an electrically conductive network is formed from at least one electrically conductive wire, there being means to close the envelope, which means also forms means to close a circuit formed by said electrically conductive network, there being means to connect said network to a device for neutralisation and/or destruction and/or signalling intended to be placed in said envelope, and wherein said network has a density that is such that an attempt at opening the envelope by cutting or tearing thereof causes the breaking of said at least one electrically conductive wire and a change in the resistance of said network capable of causing the triggering of the device for neutralisation and/or destruction and/or signalling.

2. An envelope according to claim 1, wherein the electrically conductive network is formed from a single wire disposed in successive turns in the walls of the envelope

3. An envelope according to claim 1, wherein the electrically conductive network is formed from a plurality of electrically conductive wires disposed in the walls of the envelope and connected in series.

4. An envelope according to claim 1, wherein the electrically conductive network is formed from a plurality of electrically conductive wires disposed in the walls of the envelope and connected in series, each wire being disposed in successive turns in the walls of the envelope and wherein the turns in one wall are interleaved with the turns in the other wall.

5. An envelope according to claim 4, wherein the turns in each wall of the envelope have end loops extending onto the adjacent wall.

6. An envelope according to claim 4, wherein the turns in one of the walls have end loops extending onto a side fold-over section for fixing the walls of the envelope to one another, provided on one of said walls.

7. An envelope according to claim 1, wherein said at least one conductive wire of said network is wound in a helix on the walls of the envelope.

8. An envelope according to claim 1, wherein the electrically conductive network is disposed between two sheets of plastic or paper whose superposition forms the walls of the envelope.

9. An envelope according to claim 1, wherein the electrically conductive network is incorporated into a sheet formed from the group comprising plastic and paper from which the envelope is produced.

10. An envelope according to claim 1, wherein said means of connecting the network to said device for neutralisation and/or destruction and/or signalling device comprise two flying conductors each extending an interrupted portion of the electrically conductive wire forming said network and having, at their end, means of connecting with a complementary connector of said device for neutralisation and/or destruction and/or signalling device.

11. A security device for the transport and storage of documents or valuables, comprising an envelope, wherein the envelope comprises walls, in which an electrically conductive network is formed from at least one electrically conductive wire, there being means to close the envelope, which means also forms means to close a circuit formed by said electrically conductive network, there being means to connect said network to a device for neutralisation and/or destruction and/or signalling intended to be placed in said envelope, and wherein said network has a density that is such that an attempt at opening the envelope by cutting or tearing thereof causes the breaking of said at least one electrically conductive wire and a change in the resistance of said network capable of causing the triggering of the device for neutralisation and/or destruction and/or signalling; and wherein a device is connected to said electrically conductive network, said device connected to said electrically conductive network being for neutralisation and/or destruction of the valuables contained in the envelope and/or for signalling the forcible entry of said envelope and being located in said envelope and comprising means sensitive to the change in resistance of the electrically conductive network through breaking of at least one conductive wire of said network in order to trigger the action of the device for neutralisation and/or destruction of the content of said envelope and/or for signalling its location.

12. A security device according to claim 11, wherein said device for neutralisation and/or destruction and/or signalling has a reservoir of staining and/or destroying product, distributing means, and a trigger for said reservoir, the trigger for said reservoir being controlled by a microprogrammed system connected to said conductive network of said envelope.

13. A security device according to claim 11, wherein said device for neutralisation and/or destruction and/or signalling is a target device for a monitoring and control device and the microprogrammed circuit is connected to a radio-frequency circuit for receiving periodic activation signals coming from the monitoring and control device, inside a predetermined security area defined by the monitoring and control device, and for transmitting, to said microprogrammed circuit, information about activation signal absence during a parameterisable time interval indicating the exit of said device for neutralisation and/or destruction and/or signalling out of said security area in order to cause the operation by the microprogrammed circuit of the trigger and the neutralisation and/or destruction of the valuables contained in the envelope or of said radiofrequency circuit with a view to the issuing thereby of an alarm signal.

14. A security device according to claim 13, wherein the radio-frequency circuit is sensitive to the reception, outside the period of the activation signals, of signals other than those coming from the monitoring and control device capable of causing the operation by the microprogrammed circuit of the reservoir trigger and the neutralisation and/or destruction of the valuables contained in the envelope.

15. Security device according to claim 11, wherein the first activation signal of the microprogrammed circuit is a signal for activating said device for neutralisation and/or destruction and/or signalling with a view to making it sensitive to the breaking of the electrically conductive network of said envelope in order to trigger the neutralisation and/or destruction of the valuables contained in the envelope or the triggering of an alarm.
